(19) United States
(12) Patent Application Publication
(10) Pub. No.: US 2019/0050761 A1
(43) Pub. Date: Feb. 14, 2019

(54) PRIORITIZED CONSTRAINT HANDLING TECHNIQUES FOR SOLVING OPTIMIZATION PROBLEMS

(71) Applicant: WAL-MART STORES, INC., Bentonville, AR (US)

(72) Inventors: Jagdish Ramakrishnan, San Bruno, CA (US); Matyas Attila Sustik, San Francisco, CA (US)

(73) Assignee: WAL-MART STORES, INC., Bentonville, AR (US)

(21) Appl. No.: 15/671,846

(22) Filed: Aug. 8, 2017

(51) Int. Cl. G06Q 10/04; G06N 5/02

(52) U.S. Cl. CPC G06Q 10/04; G06N 5/022

(57) ABSTRACT

Systems and methods are provided for solving optimization problems that comprise infeasible constraint sets. Priority values are assigned to the constraints in an infeasible constraint set which indicate a relative importance of the constraints to one another. A feasible constraint set is generated based on the priority values such that constraint violations of the infeasible constraint set are minimized for constraints having higher priorities. An optimization procedure is executed to identify a solution for the optimization problem using the feasible constraint set that was generated.

### TECHNICAL FIELD

This disclosure relates generally to solving optimization problems and, more particularly, to generating solutions for optimization problems involving infeasible constraint sets in a manner which minimizes constraint violations based on constraint priority information.

### BACKGROUND

Solving an optimization problem generally involves finding the best solution from all feasible solutions. Each optimization problem typically has an objective and a set of constraints to satisfy. In many cases, an optimization problem can involve large numbers of constraints that are infeasible.

Businesses or individuals may seek solutions to optimization problems for various business reasons. For example, a business may utilize optimization problems to determine optimal pricing options for products or services, or to determine optimal inventory levels. To solve such problems, businesses are required to develop extremely complex programs or scripts which typically use a series of nested “if/else” statements to define a set of feasible constraints. The programs or scripts can be very extensive in situations in which there are large numbers of constraints involved. The complexity of these programs or scripts makes it very difficult to follow the logic of the programs or scripts. In addition, updating the programs or scripts (e.g., by adding, removing or modifying constraints) is an extremely time-consuming and error prone task.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIGS. 3 and 6;

FIG. 2 illustrates a representative block diagram of an example of the elements included in the circuit boards inside a chassis of the computer system of FIG. 1;

FIG. 3 illustrates a representative block diagram of a system according to certain embodiments;

FIG. 4 is a flowchart for a method according to certain embodiments;

FIG. 5 is a flowchart for a method according to additional embodiments; and

FIG. 6 illustrates a representative block diagram of a portion of the system of FIG. 3 according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can comprise one or more processing modules and one or more non-transitory storage modules storing computing instructions configured to run on the one or more processing modules. The one or more storage modules can be configured to run on the one or more processing modules and perform the act of receiving an optimization problem that comprises an infeasible constraint set. The optimization problem is infeasible such that no solution exists which satisfies all constraints in the infeasible constraint set. The one or more storage modules also can be configured to run on the one or more processing modules and perform an act of assigning priority values to the constraints in the infeasible constraint set which indicate a relative importance of the constraints to one another. The one or more storage modules also can be configured to run on the one or more processing modules and perform an act of generating a feasible constraint set based on the priority values such that constraint violations of the infeasible constraint set are minimized based on the priority values assigned to the constraints. The one or more storage modules also can be configured to run on the one or more processing modules and perform an act of executing an optimization procedure to identify a solution for the optimization problem using the feasible constraint set that was generated.

Various embodiments include a method. The method can include receiving an optimization problem that comprises an infeasible constraint set. The optimization problem is infeasible such that no solution exists which satisfies all constraints in the infeasible constraint set. The method also can include assigning priority values to the constraints in the infeasible constraint set which indicate a relative importance of the constraints to one another. The method also can include generating, using one or more processing modules, a feasible constraint set such that constraint violations of the infeasible constraint set are minimized based on the priority values assigned to the constraints, wherein the feasible constraint set is stored on one or more non-transitory storage modules. The method also can include executing, using the one or more processing modules, an optimization procedure to identify a solution for the optimization problem using the feasible constraint set that was generated.

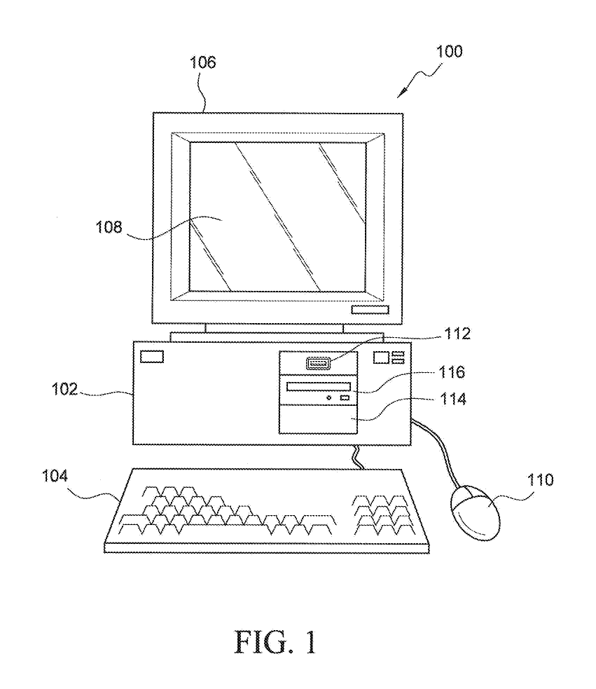

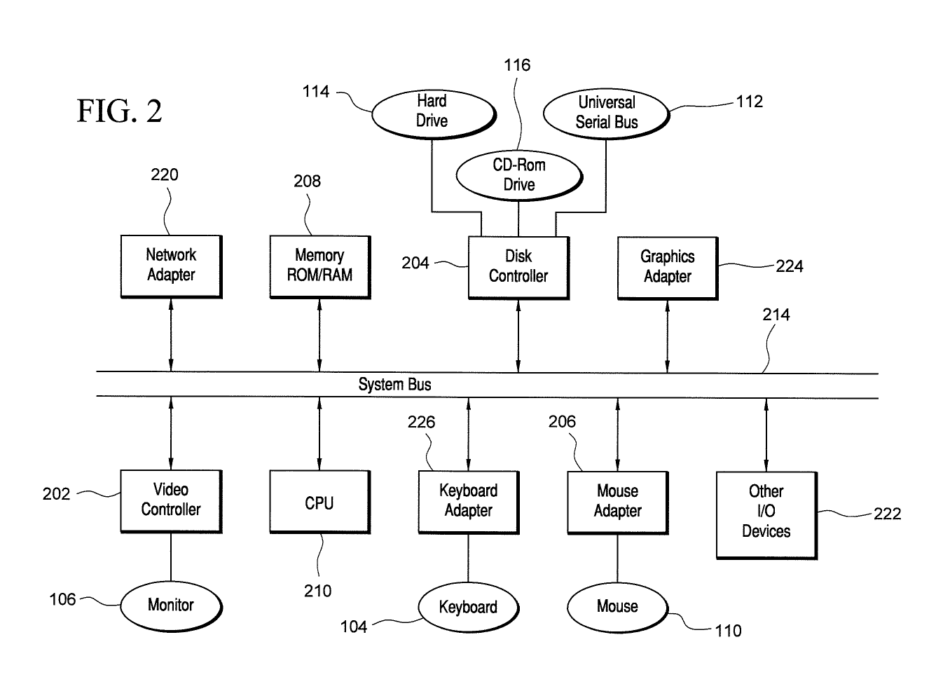

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

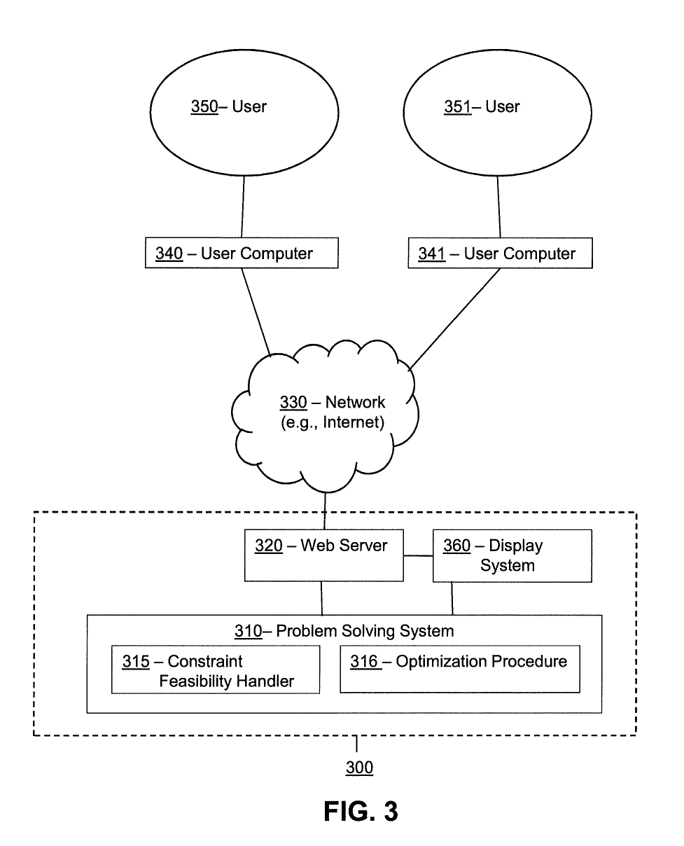

Turning ahead in the drawings, FIG. 3 illustrates a block diagram of a system 300 that can be employed for solving optimization problems described in greater detail below. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include a problem solving system 310, a constraint feasibility handler 315, one or more optimization procedures 316, a web server 320, and/or a display system 360. In the embodiment illustrated in FIG. 3, constraint feasibility handler 315 and one or more optimization procedures 316 are part of problem solving system 310. Problem solving system 310, constraint feasibility handler 315, optimization procedures 316, web server 320, and display system 360 can each be a computer system, such as computer system 100 (FIG. 1), as described above, and can each be a single computer, a single server, or a cluster or collection of computers or servers, or a cloud of computers or servers. In another embodiment, a single computer system can host each of two or more of the problem solving system 310, constraint feasibility handler 315, optimization procedures 316, web server 320, and display system 360. Additional details regarding the problem solving system 310, constraint feasibility handler 315, optimization procedures 316, web server 320, and display system 360 are described herein.

In many embodiments, system 300 also can comprise user computers 340, 341. In some embodiments, user computers 340, 341 can be mobile devices. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can comprise the Virtual Retinal Display™ product, or similar product by the University of Washington of Seattle, Wash., United States of America. Meanwhile, in further specific examples, a limb mountable wearable user computer device can comprise the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™product, Flex™ product, Charge™ product, Surge™ product, or similar product by Fitbit Inc. of San Francisco, Calif., United States of America.

In some embodiments, web server 320 can be in data communication through network 330 with user computers (e.g., 340, 341). The network may be any type of network such as one that includes the Internet, a local area network, a wide area network, an intranet, an extranet, and/or other network. In certain embodiments, user computers 340-341 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, problem solving system 310, web server 320, and display system 360 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) associated with the problem solving system 310, constraint feasibility handler 315, optimization procedures 316, web server 320, and display system 360 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of problem solving system 310, constraint feasibility handler 315, optimization procedures 316, web server 320, and display system 360. In a similar manner, the processing module(s) and the memory storage module(s) can be local and/or remote to each other.

In certain embodiments, problem solving system 310, constraint feasibility handler 315, optimization procedures 316, web server 320, and display system 360 can be configured to communicate with one or more user computers 340 and 341. In some embodiments, user computers 340 and 341 also can be referred to as customer computers. In some embodiments, problem solving system 310, constraint feasibility handler 315, optimization procedures 316, web server 320, and display system 360 can communicate or interface (e.g., interact) with one or more customer computers (such as user computers 340 and 341) through a network 330 (e.g., which includes the Internet). Network 330 can be an intranet that is not open to the public. Accordingly, in many embodiments, problem solving system 310, constraint feasibility handler 315, optimization procedures 316, web server 320, and/or display system 360 (and/or the software used by such systems) can refer to a back end of system 300 operated by an operator and/or administrator of system 300, and user computers 340 and 341 (and/or the software used by such systems) can refer to a front end of system 300 used by one or more users 350 and 351, respectively. In some embodiments, users 350 and 351 also can be referred to as customers, in which case, user computers 340 and 341 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, problem solving system 310, constraint feasibility handler 315, optimization procedures 316, web server 320, and display system 360 also can be configured to communicate with one or more databases. The one or more databases can comprise a product database that contains information about products, items, prices for products/services, and/or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication among problem solving system 310, constraint feasibility handler 315, optimization procedures 316, web server 320, and display system 360, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

Optimization problems can be used to identify ideal solutions in a variety of different scenarios, applications and industries in view of particular objectives (e.g., maximizing/minimizing values, traversing decision trees, etc.) and a set of constraints. Optimization problems can be used to select the best solutions for various purposes in nearly every industry including, but not limited to, retail, engineering, automated control systems, and pattern searching. For example, in the retail industry, optimization problems may be utilized to identify prices for products or services in view of a set of pricing constraints (e.g., constraints associated with minimum/maximum advertised pricing policies and/or variant pricing constraints). Likewise, in the context of the agricultural management systems, optimization problems may be utilized to optimize control systems in view of nutrient management constraints, environmental legal regulation constraints and/or land constraints. Similarly, in the context of complex dynamical systems and/or autonomous systems (e.g., involving autonomous vehicles or robots), optimization problems may be utilized to optimize an automated decision making process based on safety constraints and product quality constraints.

Regardless of the context in which an optimization problem is being considered, the objective or solution sought may be infeasible or non-existent. This is especially true in scenarios where large numbers of constraints are involved. Because of the various constraints that must be taken into consideration, there may be no feasible solution which satisfies each and every constraint.

Many optimizations problems are too complex to be solved manually by an individual (e.g., using a pen and paper). A human mind does not have the ability to process problems involving large numbers of variables or constraints (e.g., hundreds, thousands or even tens of thousands). It would not be possible to solve such problems because the amount of time required for computing all of the relevant possibilities would be more than a lifespan of an individual. These types of complex optimization problems can only be processed in a reasonable manner utilizing automated computing devices that are programmed to apply a specific set of rules.

The problem solving system 310 is configured to receive any and all optimization problems along with any associated constraints, and to generate solutions for maximizing or optimizing objectives based on specific rule sets. The problem solving system 310 enables the optimization problems and associated constraints to be easily added, removed and/or modified. In contrast to conventional systems which typically must develop complex programs or scripts that use a web of nested “if/else” statements to define the constraints and impose constraint priorities, the problem solving system 310 provides a set of functions for dynamically adding, removing and modifying constraints (e.g., such as linear constraints, sparse linear constraints, convex constraints, and/or other types of constraints). For example, in certain embodiments, a function allows a constraint to be easily added or modified by receiving a first input that includes a list of coefficients associated with the constraint being added or modified (e.g., coefficients for an algebraic or linear expression), and a second input that specifies a priority value for the constraint which is being added or modified. The functions also allow the user to remove constraints by providing an input that identifies a previously defined constraint. Thus, when constraints need be added, modified or removed over the course of time, the user is not required to modify an extensive web of “if/else” statements and/or a complex program, both of which can be extremely prone to errors. Instead, the user can simply add, remove or modify the constraints using the functions. The user can also easily reorder the priority values assigned to the constraints by simply changing the inputs to the functions.

The problem solving system 310 is configured to determine whether inputted optimization problems are feasible or infeasible based on their associated constraint sets. As explained in further detail below, the problem solving system 310 is configured to generate solutions for both optimization problems that have feasible constraint sets and optimization problems that have infeasible constraint sets. The solutions may then be output on an interface via a display system 360.

In response to receiving an optimization problem which includes a feasible constraint set, the problem solving system 310 may utilize one or more optimization procedures 316 to generate a solution for the optimization problem. The one or more optimization procedures 316 may execute one or more optimization functions to generate the solution. For example, in the context of optimizing prices, the one or more optimization procedures 316 may execute any price optimization algorithm, method, model and/or function including, but not limited to, any which are based on heuristic methods, numerical optimization methods, strict mathematical methods, forecasting methods (e.g., forecasting time-phased demand methods, forecasting granular demand methods and casual methods), revenue optimization models, price-response functions, competitor pricing models, loss leader pricing models, quick delivery pricing models, real-time price optimization models, and/or other price optimization functions. Regardless of which optimization function is applied, the one or more optimization procedures 316 can generate a solution for any optimization problem with a feasible constraint set.

In response to receiving an optimization problem which includes an infeasible constraint set such that no solution exists which satisfies all of the constraints in the set, the problem solving system 310 may initially execute the constraint feasibility handler 315 to generate a feasible constraint set from the infeasible constraint set. In certain embodiments, priority values are assigned to each of the constraints in the infeasible constraint set, and the constraint feasibility handler 315 is configured to generate a feasible constraint set in a manner which minimizes constraint violations for constraints that have higher priorities. That is, a new feasible constraint set is generated from the constraints in the infeasible constraint set utilizing a procedure which revises the constraints to be produce a feasible solution and which does so based on priorities assigned to the constraints. As explained in further detail below, this may be accomplished, at least in part, by sequentially solving optimization sub-problems associated with each of the constraints included in the infeasible constraint set and incorporating slack variables to modify the constraints. The constraint feasibility handler 315 may initially be configured to solve an optimization sub-problem for the constraint having the highest priority, and then iteratively solve optimization sub-problems for constraints with decreasing priority. Slack variables can be incorporated into the constraints to make the overall optimization problem feasible throughout this process. Modifications to the constraints from previous iterations can be carried to future iterations. After a new feasible constraint set is generated, the problem solving system 310 may execute the one or more optimization procedures 316 to generate a solution for the optimization problem using the revised set of feasible constraints.

In certain embodiments, executing the optimization procedure comprises changing at least one price of the one or more products or services to create one or more modified prices based on the feasible constraint set. After executing the optimization procedure, the at least one modified price may be displayed on a screen of an electronic device (e.g., an electronic device associated with display system 360). The at least one modified price may also be transmitted over a network 330 to one or more user computers (e.g., 340 and/or 341) for variety of different purposes. Exemplary purposes may include updating pricing information for products and/or services that are offered for purchase via a website and/or updating a database that includes pricing information for products and/or services made available at physical retail locations.

An example is described below to illustrate the manner in which problem solving system 310 is able to generate a solution from an infeasible constraint set. In this example, the objective of the optimization problem is to minimize the vector x subject to a set of constraints:

$${minim}_{x} ize {f}_{0} ( x )$$

$$\begin{matrix}subject to & {f}_{i}^{1} ( x ) \leq 0 , i = 1 , … , {m}_{1} \\ & {f}_{i}^{2} ( x ) \leq 0 , i = 1 , … , {m}_{2} \\ & ⋮ \\ & {f}_{i}^{n} ( x ) \leq 0 , i = 1 , … , {m}_{n} ,\end{matrix}$$

where:
f₀(x) is the objective function to be minimized;
ƒᵢ¹(x) through ƒᵢⁿ(x) represent convex constraint functions with priorities 1 through n;
x is the vector being minimized by the objective function;
n is the total number of priorities;
i is the index over a set of constraints; and
mⱼ is the total number of constraints that have priority j.
   The functions ƒᵢ¹(x)≤0, i=1, . . . , m₁ have the highest priority, and the functions of ƒᵢⁿ(x)≤0, i=, . . . , mₙ, have the lowest priority. The constraint feasibility handler 315 is configured to identify a feasible constraint set that minimizes constraint violations in the order of constraint priority, e.g., a constraint ƒᵢ²(x) would be violated before ƒᵢ¹(x) when it is not possible to satisfy both of them.

For each of the above constraints, the constraint feasibility handler 315 sequentially attempts to modify the constraints to provide a feasible constraint set, starting with the constraint having the highest priority and iteratively selecting the next constraint with decreasing priority. For each set of constraints, the constraint feasibility handler 315 can introduce slack variables and minimize constraint violations while keeping higher priority constraints with slack variables from previous iterations. The algorithm or pseudocode reproduced below illustrates an exemplary manner in which the constraint feasibility handler 315 can produce a feasible constraint set from an infeasible constraint set while minimizing constraint violations for prioritized constraints.

```
Input: fᵢ^{j} (x), i = 1, . . . , mⱼ, j = 1, . . . , n.
Output: sᵢⱼ*, i = 1, . . . , mⱼ, j = 1, . . . , n (constraints with violations
minimized)
  for (j = 1; j ← j + 1; j ≤ n) do
    Solve optimization problem
$\begin{matrix}minimize & {Σs}_{ij} \\ x , s & i \\ subject to & {f}_{i}^{1} ( x ) \leq {s}_{i 1}^{*} , , i = 1 , … , {m}_{1} \\ & ⋮ \\ & {f}_{i}^{j - 1} ( x ) \leq {s}_{i ( j - 1 )}^{*} , i = 1 , … , {m}_{j - 1} \\ & {f}_{i}^{j} ( x ) \leq {s}_{ij} , i = 1 , … , {m}_{j} , \\ & {s}_{ij} \geq 0 , i = 1 , … , {m}_{j} ,\end{matrix}$
      such that sᵢₖ*, k = 1, . . . , j−1 are the optimized slack
      values from previous solutions
    where:
      Σsᵢⱼ is the objective function, which uses the I1 norm, but
other norms can be used here;
      f ᵢ¹(x) through f ᵢⁿ(x) represent convex constraint functions
with priorities 1 through n;
      x is the vector being minimized by the objective function;
      sᵢⱼ is the slack variable for ith constraint with jth priority;
      j is the priority value for the last set of constraints for which
we are optimizing slack values;
      i is the index over a set of constraints;
      mⱼ is the total number of constraints that have priority j; and
      n is the total number of priorities.
  end for
```

The output of the above algorithm or pseudocode is a feasible constraint set that minimizes constraint violations in an order or priority based on priority values that are assigned to, or associated with, the constraints. Having produced a feasible constraint set, the one or more optimization procedures 316 can utilize an appropriate optimization function (e.g., algorithm, method and/or model) to generate an optimal solution for the optimization problem, e.g., such as:

$$\begin{matrix}{minimize}_{x} & {f}_{0} ( x ) \\ subject to & {f}_{i}^{1} ( x ) \leq {s}_{i 1}^{*} , i = 1 , … , {m}_{1} \\ & {f}_{i}^{2} ( x ) \leq {s}_{i 2}^{*} , i = 1 , … , {m}_{2} \\ & ⋮ \\ & {f}_{i}^{n} ( x ) \leq {s}_{in}^{*} , i = 1 , … , {m}_{n} .\end{matrix}$$

where:
f₀(x) is the objective function to be minimized;
ƒᵢ¹(x) through ƒᵢⁿ(x) represent convex constraint functions with priorities 1 through n;
x is the vector being minimized by the objective function;
sᵢⱼ^{*} is the optimized slack value for the ith constraint with jth priority;
i is the index over a set of constraints;
mⱼ is the total number of constraints that have priority j; and
n is the total number of priorities.

Another example is described below which illustrates the manner in which problem solving system 310 is able to generate a solution to an optimization problem that includes an infeasible constraint set. This example is specifically directed to a price optimization problem that includes an infeasible set of pricing constraints. It should be recognized that the problem solving system 310 can apply similar to generate solutions to other types of optimization problems.

In this example, p is the price vector for N items with components pᵢ, p₂, . . . , p_{N}. Any linear constraint can be represented as using the following form: c₀+c₁p₁+. . . +c_{N}p_{N}≤0. In this example, all constraints are converted to this form.

In certain embodiments, the problem solving system 310 can initialize an instance of the constraint feasibility handler 315 using the following program instructions or pseudocode:

h=FeasibilityHandler(num_var=N).

Linear constraints and sparse linear constraints can then be added with the functions described below:
add_lin_constraint(coef, priority)—where coef is a list containing the coefficients [c₀, c_{I}, . . . , c_{N}] of a linear function of the form describe above, and where priority is a positive integer indicating the priority of the constraint. For example, if it is desired to enforce the constraint p₁<=10 with priority 2 for N=2, the following function call can be used: h.add_lin_constraint ([−10, 1, 0], 2).
add_sparse_lin_constraint(sparse_coef, priority)—where sparse_coef is a list of length 2 tuples of the form (coef_index, value), and where priority is again a positive integer indicating the priority of the constraint. This function is especially useful in cases where there are very few non-zero entries in coefficients of the linear function. For example, if N=100, and it is desired to enforce the constraint p₈₀ <=5 with priority 1, the following function call can be used: h.add_sparse_lin_constraint ([(0, −5), (80, 1)], 1).

Once all of the constraints and their priorities are added, the constraint feasibility handler 315 can use the solve function to solve the feasibility problem: h.solve( ).

The constraint feasibility handler 315 utilizes slack variables to generate the feasible constraint set. To obtain the slack variables, the constraint feasibility handler 315 can use the get_slack_vals function, which will return the optimal slack values from solving the problem: slack_vals=h.get_slack_vals( ). To obtain a point in the new feasible set represented by the slack variables, the constraint feasibility handler 315 can use the function get_feasible_point( ): e.g., var_values=h.get_feasible_point( ).

Complications are introduced in cases where the pricing optimization problem includes variant constraints. Generally speaking, “variant” products or services refer to similar products or services that are typically priced the same or similarly. Examples of variants may include T-shirts having different sizes or colors, but which are otherwise similar. Price optimization problems may impose pricing constraints on variant products or services.

Below is an example of how the constraint feasibility handler 315 can generate a feasible constraint set for a price optimization problem that includes variant constraints for two items that are variants of one another. The variable of interest is the price vector p=(p₁, p₂). For this example, assume the constraints listed below have been input to constraint feasibility handler 315 (listed in the order of priority):
1. Minimum advertised price (MAP) constraints: 5≤p₁, 16≤p₂,
2. Manufacturer's suggested retail price (MSRP) constraints: P₁≤15, p₂≤18
3. Merchant price constraints: 10≤p1≤17
4. Variant constraints: p₁=p₂ [symbol] p₁≤p₂ and p₂≤p₁
5. Minimum competitor price constraint: p₁≤14.

To generate a feasible solution, the above constraints can be translated into linear form as shown below and the constraint feasibility handler 315 can be called (e.g., h=FeasibilityHandler(num_var=2)).
# MAP
h.add_lin_constraint ([5, −1, 0], 1)
h.add_lin_constraint ([16, 0, −1], 1)
# MSRP
h.add_lin_constraint ([−15, 1, 0], 2)
h.add_lin_constraint ([−18, 0, 1], 2)
# Merchant price
h.add_lin_constraint ([10, −1, 0] 3)
h.add_lin_constraint ([−17, 1, 0], 3)
# Variants
h.add_lin_constraint ([0, 1, −1], 4)
h.add_lin_constraint ([10, −1, 1], 4)
# Minimum competitor price
h.add_lin_constraint ([−14, 1, 0], 5)
h.solve ( )
slack_vats=h.get_slack_vals ( )
var_values=h.get_feasible_point ( )

The result will be that these variants have prices that are impossible to match due to the competing MAP and MSRP constraints. To generate a feasible constraint set, the constraint feasibility handler 315 can relax the two lowest priority constraints (minimum competitor price and variant) by incorporating slack values into the constraints. Here, a feasible point may be p₁=15 and p₂ =16.

Enforcing variant constraints for more than two items is more complicated. To illustrate the intricacies involved, consider the following three item example. The price variables under consideration for these three items are p₁, p₂, and p₃. Assume there is a set of existing price bounds on three variant products (of higher priority than the variant constraints) as follows: 5≤p₁≤12; 10 p₂≤15; and 13≤p₃≤20. To enforce equality constraints of the form f(x)=0, the constraint feasibility handler 315 can apply the following two constraints: f(x)≤0 and −f(x)0. If the constraint feasibility handler 315 enforces all of the three possible combinations (i.e., p₁≤p₂; p₂≤p₁; p₁≤p₃; p₃≤p₁; p₂≤p₃; and p₃≤p₂) and minimizes l₁ the norm, the result is any one of the following three solutions for the slack variables of the variant constraints:

$$[ \begin{matrix}0 \\ 1 \\ 0 \\ 1 \\ 0 \\ 0\end{matrix} ] or [ \begin{matrix}0 \\ 0 \\ 0 \\ 1 \\ 0 \\ 1\end{matrix} ] or [ \begin{matrix}0 \\ 1 / 2 \\ 0 \\ 1 \\ 0 \\ 1 / 2\end{matrix} ] .$$

The last of the above solutions, which corresponds to p₁=12, p₂ =12.5, and p₃=13, may not be ideal because all three of the variants are priced differently. The constraint feasibility handler 315 can apply or assign different priorities to the variant constraints to avoid such solutions and enforce minimal differing variant prices. Specifically, the nominal (or current retail price) can be ordered in descending order and equality constraints may be applied only on adjacent items in this ordered group. Priorities of these equality constraints would also be descending with each new constraint. For example, suppose the nominal (current) prices of the example items are p₁=8.50, p₂=12.5, and p₃=16.5. Ordering the nominal prices from largest to smallest would then result in p₃, p₂, and p₁. The constraint feasibility handler 315 can apply the variant constraints p₃=p₂ with a higher priority than p₂=p₁. The result will be that the constraint feasibility handler 315 identifies a solution with prices corresponding to p₁=12, p₂ =13, and p₃=13, which may be a better solution because it has only a single variant constraint violation.

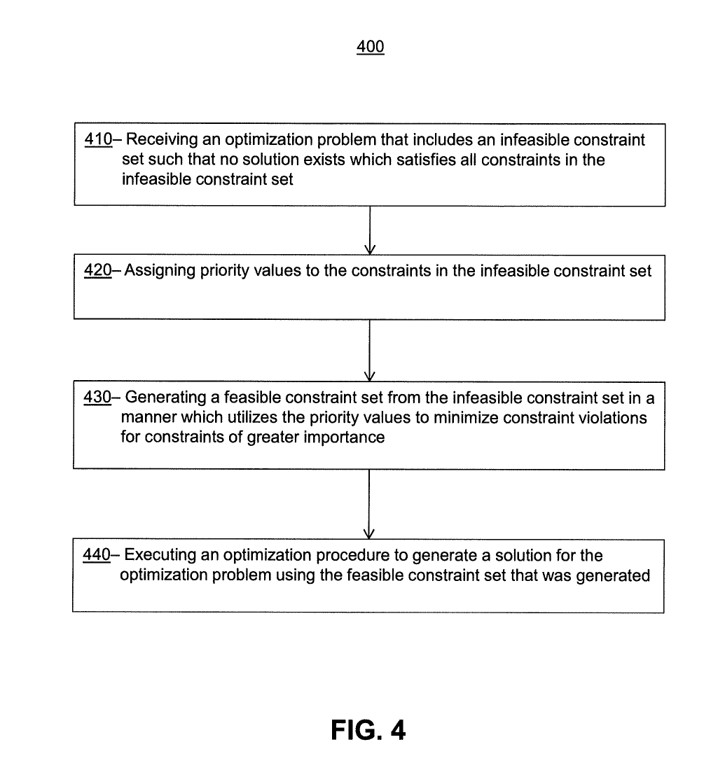

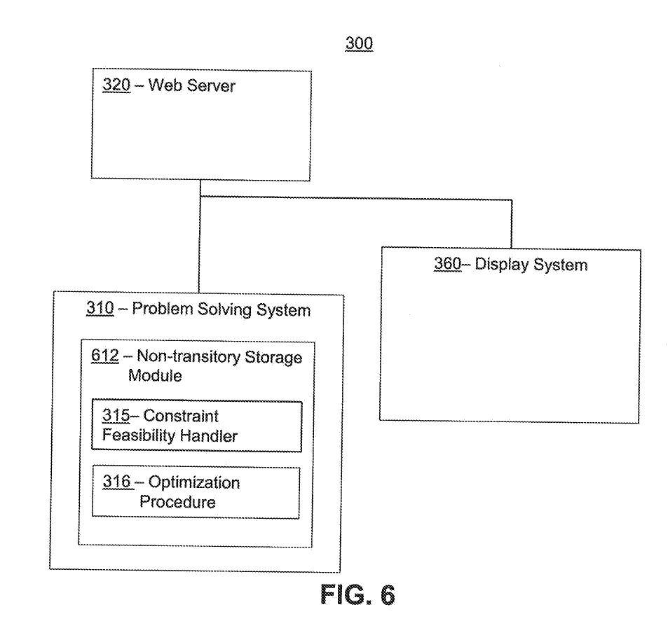

Turning ahead in the drawings, FIG. 4 illustrates a flow chart for a method 400 according to certain embodiments. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) and/or problem solving system 310 can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules 612 (FIG. 6). Such non-transitory memory storage modules can be part of a computer system such as problem solving system 310 (FIGS. 3 & 6). The processing module(s) can be similar or identical to the processing module(s) described above with respect to computer system 100 (FIG. 1).

Method 400 can comprise an activity 410 of receiving an optimization problem that includes an infeasible constraint set such that no solution exists which satisfies all constraints in the infeasible constraint set. In certain embodiments, the optimization problem may relate to a price optimization problem. In certain embodiments, the optimization problem relates to other types of optimization problems such as those associated with optimizing dynamical or autonomous systems (e.g., optimizing control systems for autonomous vehicles in view of safety constraints), agriculture management systems (e.g., optimizing control systems in view of nutrient distribution constraints and environmental regulation constraints), and/or other types of systems (e.g., associated with engineering, control systems, pattern searching, etc.). In certain embodiments, the constraints can be received via one or more functions for inputting linear, sparse linear constraints, and/or convex constraints). The one or more functions can receive inputs that specify coefficients (and/or other information), and the functions transform the input into linear and/or sparse linear form.

Method 400 can further comprise an activity 420 of assigning priority values to the constraints in the infeasible constraint set. The priority values can be utilized to determine an importance of the constraints relative to one another. In certain embodiments, the one or more functions utilized to specify the constraints can also receive inputs for designating priority values of the constraints and associating the priority values with the constraints.

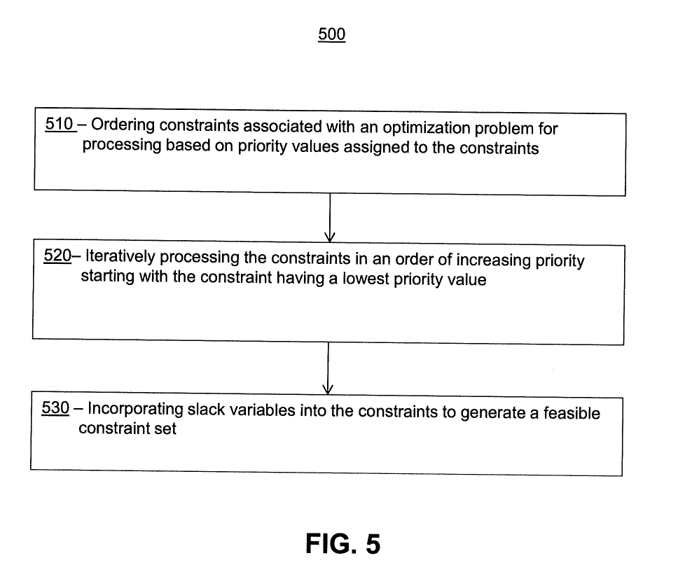

Method 400 can further comprise an activity 430 of generating a feasible constraint set from the infeasible constraint set in a manner which utilizes the priority values to minimize constraint violations for constraints of greater importance. As explained above, this activity may be performed by the constraint feasibility handler 315, at least in part, by processing the constraints in the infeasible constraint set in an order of increasing priority and incorporating slack values to generate a feasible constraint. FIG. 5 describes an exemplary method 500 for performing this activity 430.

Method 400 can further comprise an activity 440 of executing an optimization procedure to generate a solution for the optimization problem using the feasible constraint set that was generated. As explained above, the problem solving system 310 may store data or information for one or more optimization procedures 316. The problem solving system 310 may further be configured to select appropriate ones of optimization procedures 316 to process the feasible constraint set that was generated and to produce a solution associated with the objective of the optimization problem.

FIG. 5 illustrates a flow chart for a method 500 according to certain embodiments. Method 400 is merely exemplary and is not limited to the embodiments presented herein. Method 500 can be employed in many different embodiments or examples not specifically depicted or described herein. In some embodiments, the activities of method 500 can be performed in the order presented. In other embodiments, the activities of method 500 can be performed in any suitable order. In still other embodiments, one or more of the activities of method 500 can be combined or skipped. In many embodiments, system 300 (FIG. 3) and/or problem solving system 310 can be suitable to perform method 500 and/or one or more of the activities of method 500. In these or other embodiments, one or more of the activities of method 500 can be implemented as one or more computer instructions configured to run at one or more processing modules and configured to be stored at one or more non-transitory memory storage modules 612 (FIG. 6). Such non-transitory memory storage modules can be part of a computer system such as problem solving system 310 (FIGS. 3 & 6). The processing module(s) can be similar or identical to the processing module(s) described above with respect to computer system 100 (FIG. 1).

Method 500 can comprise an activity 510 of ordering constraints associated with an optimization problem for processing based on priority values assigned to the constraints. For example, the constraints associated with an optimization can be ordered from lowest priority to greatest priority.

Method 500 can further comprise an activity 520 of iteratively processing the constraints in an order of increasing priority starting with the constraint having a lowest priority value. At each iteration, the constraint feasibility handler 315 may solve optimization sub-problems associated with each of the constraints that are processed as explained above.

Method 500 can further comprise an activity 530 of incorporating slack variables into the constraints to generate a feasible constraint set. Slack variables can be incorporated into the constraints during each iteration. Slack variables incorporated from previous iterations can be carried to future iterations. The slack variables are incorporated in a manner which reduces constraint violations for higher priority constraints to the extent possible.

FIG. 6 illustrates a block diagram of a portion of system 300 comprising the problem solving system 310, the constraint feasibility handler 315, one or more optimization procedures 316, the web server 320, and the display system 360, according to the embodiment shown in FIG. 3. Each of problem solving system 310, the constraint feasibility handler 315, one or more optimization procedures 316, the web server 320, and the display system 360 is merely exemplary and not limited to the embodiments presented herein. Each of problem solving system 310, the constraint feasibility handler 315, one or more optimization procedures 316, the web server 320, and the display system 360 can be employed in many different embodiments or examples not specifically depicted or described herein. In some embodiments, certain elements or modules of problem solving system 310, the constraint feasibility handler 315, one or more optimization procedures 316, the web server 320, and the display system 360 can perform various procedures, processes, and/or acts. In other embodiments, the procedures, processes, and/or acts can be performed by other suitable elements or modules.

In many embodiments, problem solving system 310 can comprise non-transitory memory storage modules 612. Memory storage module 612 can be referred to as optimization module 612. In many embodiments, optimization module 612 can store computing instructions configured to run on one or more processing modules and perform one or more acts of methods 400 (FIGS. 4) and 500 (FIG. 5) (e.g., activities 410, 420, 430, 440, 510, 520 and 530) in connection with generating solutions for optimization problems or performing other related activities. For example, in certain embodiments, instructions for performing activities 410, 420, 430, 440, 510, 520 and 530 may be stored on non-transitory storage medium 612, and acts 410, 420, 430, 510, 520 and 530 may be performed by the constraint feasibility handler 315 while activity 440 may be performed by the one or more optimization procedures 316.

Although systems and methods for processing optimization problems have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIGS. 4 and 5 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules; and
one or more non-transitory storage modules storing computing instructions configured to run on the one or more processing modules and perform acts of:
receiving an optimization problem that comprises an infeasible constraint set, the optimization problem being infeasible such that no solution exists which satisfies all constraints in the infeasible constraint set;
assigning priority values to the constraints in the infeasible constraint set, the priority values indicating a relative importance of the constraints to one another;
in response to determining that the optimization problem is infeasible, generating a feasible constraint set such that constraint violations of the infeasible constraint set are minimized based on the priority values assigned to the constraints; and
executing an optimization procedure to identify a solution for the optimization problem using the feasible constraint set that was generated.

2. The system of claim 1, wherein generating the feasible constraint set based on the priority values comprises:
sequentially processing optimization sub-problems associated with the constraints included in the infeasible constraint set by incorporating slack variables to modify the constraints.

3. The system of claim 2, wherein the constraints in the infeasible constraint are processed in an order of decreasing priority such that the constraints having higher priority values are processed before the constraints having lower priority values.

4. The system of claim 3, wherein modifications to the constraints incorporated during processing of previous sub-problems are carried throughout future iterations.

5. The system of claim 1, wherein the optimization problem is associated with optimizing pricing information for one or more products or services.

6. The system of claim 5, wherein:
the constraints are related to enforcing restrictions associated with at least two of the following: a minimum advertised price; a maximum advertised price; a manufacturer's suggested retail price; a variant price restriction for one or more related products or services; a competitor price; and a pack size;
executing the optimization procedure comprises changing at least one price of the one or more products or services to create a modified at least one price based on the feasible constraint set; and
the acts further comprise, after executing the optimization procedure, coordinating a display of the at least one modified price on a screen of an electronic device.

7. The system of claim 5, wherein:
the constraints comprise variant constraints for enforcing pricing bounds on two or more items of the one or more products or services; and
generating the feasible constraint set comprises:
creating an ordered list of the two or more items based on nominal prices associated with the two or more items;
modifying the constraints such that equality constraints are only applied on adjacent items of the ordered list; and
applying different priority values for each of the modified constraints.

8. The system of claim 1, wherein the each of the constraints is a linear constraint or a sparse linear constraint.

9. The system of claim 1, wherein:
one or more functions permit linear constraints and sparse linear constraints to be dynamically added or modified; and
the one or more functions are configured to receive: (i) a first input that comprises a list of coefficients associated with a linear constraint or a sparse linear constraint which is being added or modified; and (2) a second input that specifies a priority value for the linear constraint or the sparse linear constraint which is being added or modified.

10. The system of claim 1, the optimization procedure identifies the solution based, at least in part, on:
$$\begin{matrix}{minimize}_{x} & {f}_{0} ( x ) \\ subject to & {f}_{i}^{1} ( x ) \leq {s}_{i 1}^{*} , i = 1 , … , {m}_{1} \\ & {f}_{i}^{2} ( x ) \leq {s}_{i 2}^{*} , i = 1 , … , {m}_{2} \\ & ⋮ \\ & {f}_{i}^{n} ( x ) \leq {s}_{in}^{*} , i = 1 , … , {m}_{n} .\end{matrix}$$
where:
f₀(x) is the objective function to be minimized;
ƒᵢ ¹(x) through ƒᵢ ⁿ(x) represent convex constraint functions with priorities 1 through n;
x is the vector being minimized by the objective function;
sᵢⱼ ^{*} is the optimized slack value for the ith constraint with jth priority;
i is the index over a set of constraints;
mⱼ is the total number of constraints that have priority j; and
n is the total number of priorities.

11. A method comprising:
receiving an optimization problem that comprises an infeasible constraint set, the optimization problem being infeasible such that no solution exists which satisfies all constraints in the infeasible constraint set;
assigning priority values to the constraints in the infeasible constraint set, the priority values indicating a relative importance of the constraints to one another;
in response to determining that the optimization problem is infeasible, generating, using one or more processing modules, a feasible constraint set such that constraint violations of the infeasible constraint set are minimized based on the priority values assigned to the constraints, wherein the feasible constraint set is stored on one or more non-transitory storage modules; and
executing, using the one or more processing modules, an optimization procedure to identify a solution for the optimization problem using the feasible constraint set that was generated.

12. The method of claim 11, wherein generating the feasible constraint set based on the priority values comprises:
sequentially processing optimization sub-problems associated with the constraints included in the infeasible constraint set by incorporating slack variables to modify the constraints.

13. The method of claim 12, wherein the constraints in the infeasible constraint are processed in an order of decreasing priority such that the constraints having higher priority values are processed before the constraints having lower priority values.

14. The method of claim 13, wherein modifications to the constraints incorporated during processing of previous sub-problems are carried throughout future iterations.

15. The method of claim 11, wherein the optimization problem is associated with optimizing pricing information for one or more products or services.

16. The method of claim 15, wherein
the constraints are related to enforcing restrictions associated with at least two of the following: a minimum advertised price; a maximum advertised price; a manufacturer's suggested retail price; a variant price restriction for one or more related products or services; a competitor price; and a pack size;
executing the optimization procedure comprises changing at least one price of the one or more products or services to create a modified at least one price based on the feasible constraint set; and
the method further comprises, after executing the optimization procedure, coordinating a display of the at least one modified price on a screen of an electronic device.

17. The method of claim 15, wherein:
the constraints comprise variant constraints for enforcing pricing bounds on two or more items of the one or more products or services, and
generating the feasible constraint set comprises:
creating an ordered list of the two or more items based on nominal prices associated with the two or more items;
modifying the constraints such that equality constraints are only applied on adjacent items of the ordered list; and
applying different priority values for each of the modified constraints.

18. The method of claim 11, wherein the each of the constraints is a linear constraint or a sparse linear constraint.

19. The method of claim 11, wherein:
one or more functions permit linear constraints and sparse linear constraints to be dynamically added or modified; and
the one or more functions are configured to receive: (i) a first input that comprises a list of coefficients associated with a linear constraint or a sparse linear constraint which is being added or modified; and (2) a second input that specifies a priority value for the linear constraint or the sparse linear constraint which is being added or modified.

20. The system of claim 11, the optimization procedure identifies the solution based, at least in part, on:
$$\begin{matrix}{minimize}_{x} & {f}_{0} ( x ) \\ subject to & {f}_{i}^{1} ( x ) \leq {s}_{i 1}^{*} , i = 1 , … , {m}_{1} \\ & {f}_{i}^{2} ( x ) \leq {s}_{i 2}^{*} , i = 1 , … , {m}_{2} \\ & ⋮ \\ & {f}_{i}^{n} ( x ) \leq {s}_{in}^{*} , i = 1 , … , {m}_{n} .\end{matrix}$$
where:
f₀(x) is the objective function to be minimized;
ƒᵢ¹(x) through ƒᵢⁿ(x) represent convex constraint functions with priorities 1 through n;
x is the vector being minimized by the objective function;
sᵢⱼ^{*} is the optimized slack value for the ith constraint with jth priority;
i is the index over a set of constraints;
mⱼ is the total number of constraints that have priority j; and n is the total number of priorities.
